(19) United States
(12) Patent Application Publication
(10) Pub. No.: US 2014/0195671 A1
(43) Pub. Date: Jul. 10, 2014

(54) METHOD AND APPARATUS PROVIDING DELAYED PATH CALCULATIONS BASED ON SERVICE TYPE

(71) Applicant: Daniel Joyal, Belmont, MA (US)

(72) Inventor: Daniel Joyal, Belmont, MA (US)

(73) Assignee: AVAYA INC., Basking Ridge, NJ (US)

(21) Appl. No.: 13/737,415

(22) Filed: Jan. 9, 2013

(51) Int. Cl. H04L 12/24

(52) U.S. Cl. CPC H04L 41/00
USPC 709/224

(57) ABSTRACT

A method, apparatus and computer program product for providing delayed path calculations based on service type is presented. A first network device sends to at least one of a plurality of other network devices in a network, link state information directing receivers of the link state information, when computing routes transiting though the first network device, to refrain from using the first network device on at least one of the group consisting of per Network Layer Protocol Identifier (NLPID), per address family, and per service within an address family.

### BACKGROUND

Intermediate System to Intermediate System (ISIS) is a routing protocol designed to move information efficiently within a computer network, a group of physically connected computers or similar devices. ISIS accomplishes this by determining the best route for packets through a packet-switched network. The protocol was defined in ISO/IEC 10589:2002 as an international standard within the Open Systems Interconnection (OSI) reference design. Though originally an ISO standard, the IETF republished the protocol as an Internet Standard in RFC 1142. IS-IS has been called the de facto standard for large service provider network backbones.

Shortest Path Bridging (SPB) uses ISIS as the control protocol to transfer routing information between devices in an SPB Network acting as a transport network between access networks which may be running different protocols. In an SPB network, the ISIS Link State Database (LSDB) is used to advertise routing information. In addition to information about adjacencies with other SPB enabled devices the LSDB also includes reachability information for services outside the SPB network. Examples are—IPv4 Unicast routes, IPv4 Multicast Routes, IPv6 Unicast routes, IPv6 multicast routes, L2 and L3 virtual Service networks (VSNs), Unicast Backbone Media Access Control (BMAC) addresses etc.

When ISIS comes up, there is certain information that needs to be learned (link state information, etc.) in order to build forwarding tables. There can be a lot of churn in all the nodes as the learning of the information happens simultaneously. This in turn can result in nodes have an inconsistent view of the network. This is especially true in larger networks or networks where different routing protocols are used within the same network. It may be convenient at times for a router originating link state information to control its usage by other nodes in the network. In this case the control is in signaling other nodes as to when to use the link state information to compute paths transiting through the originating node.

One known solution is to set the overload bit field in Link State Packet (LSP) 0 to artificially create a condition where the other nodes in the ISIS network will not compute routes transiting through the advertising node. When the advertising node is ready to signal other nodes to compute transit routes through it, it will update its LSP 0 to clear the overload bit and flood the LSP. All major router vendors support the use of the overload bit to delay route computation through an advertising ISIS node.

### SUMMARY

Conventional mechanisms such as those explained above suffer from a variety of deficiencies. The use of the overload bit is a coarse solution as it prevents all types of routes carried in ISIS from being computed. It is desirable to have a finer level of control where delayed route computation can be applied at different hierarchical levels, for example applied at a highest level on a per Network Layer Protocol Identifier (NLPID) level, at a next lower level on a per address family, at a lower level on a per service type within an address family, collectively referred to as service type.

Embodiments of the invention significantly overcome such deficiencies and provide mechanisms and techniques that provide delayed path calculations based on service type. This provides a granular capability for an advertising node using ISIS to control route calculation by other nodes through the advertising node.

In a particular embodiment of a method for providing delayed path calculations based on service type, the method includes sending, by a first network device to at least one of a plurality of other network devices in a network, link state information directing receivers of the link state information, when computing routes transiting though the first network device, to refrain from using the first network device on at least one of the group consisting of per Network Layer Protocol Identifier (NLPID), per address family, and per service within an address family.

Other embodiments include a computer readable medium having computer readable code thereon for providing delayed path calculations based on service type. The computer readable medium includes instructions for sending, by a first network device to at least one of a plurality of other network devices in a network, link state information directing receivers of the link state information, when computing routes transiting though the first network device, to refrain from using the first network device on at least one of the group consisting of per Network Layer Protocol Identifier (NLPID), per address family, and per service within an address family.

Still other embodiments include a computerized device, configured to process all the method operations disclosed herein as embodiments of the invention. In such embodiments, the computerized device includes a memory system, a processor, communications interface in an interconnection mechanism connecting these components. The memory system is encoded with a process that provides delayed path calculations based on service type as explained herein that when performed (e.g. when executing) on the processor, operates as explained herein within the computerized device to perform all of the method embodiments and operations explained herein as embodiments of the invention. Thus any computerized device that performs or is programmed to perform up processing explained herein is an embodiment of the invention.

Other arrangements of embodiments of the invention that are disclosed herein include software programs to perform the method embodiment steps and operations summarized above and disclosed in detail below. More particularly, a computer program product is one embodiment that has a computer-readable medium including computer program logic encoded thereon that when performed in a computerized device provides associated operations providing delayed path calculations based on service type as explained herein. The computer program logic, when executed on at least one processor with a computing system, causes the processor to perform the operations (e.g., the methods) indicated herein as embodiments of the invention. Such arrangements of the invention are typically provided as software, code and/or other data structures arranged or encoded on a computer readable medium such as an optical medium (e.g., CD-ROM), floppy or hard disk or other a medium such as firmware or microcode in one or more ROM or RAM or PROM chips or as an Application Specific Integrated Circuit (ASIC) or as downloadable software images in one or more modules, shared libraries, etc. The software or firmware or other such configurations can be installed onto a computerized device to cause one or more processors in the computerized device to perform the techniques explained herein as embodiments of the invention. Software processes that operate in a collection of computerized devices, such as in a group of data communications devices or other entities can also provide the system of the invention. The system of the invention can be distributed between many software processes on several data communications devices, or all processes could run on a small set of dedicated computers, or on one computer alone.

It is to be understood that the embodiments of the invention can be embodied strictly as a software program, as software and hardware, or as hardware and/or circuitry alone, such as within a data communications device. The features of the invention, as explained herein, may be employed in data communications devices and/or software systems for such devices such as those manufactured by Avaya, Inc. of Basking Ridge, N.J.

Note that each of the different features, techniques, configurations, etc. discussed in this disclosure can be executed independently or in combination. Accordingly, the present invention can be embodied and viewed in many different ways. Also, note that this summary section herein does not specify every embodiment and/or incrementally novel aspect of the present disclosure or claimed invention. Instead, this summary only provides a preliminary discussion of different embodiments and corresponding points of novelty over conventional techniques. For additional details, elements, and/or possible perspectives (permutations) of the invention, the reader is directed to the Detailed Description section and corresponding figures of the present disclosure as further discussed below.

### BRIEF DESCRIPTION OF THE DRAWINGS

The foregoing will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 depicts a high level block diagram of a network including devices that perform delayed path calculations based on service type in accordance with embodiments of the invention;

FIG. 2 comprises a flow diagram of a particular embodiment of a method for performing delayed path calculations based on service type in accordance with embodiments of the invention; and

FIG. 3 illustrates an example computer system architecture for a computer system (a network device) that performs delayed path calculations based on service type in accordance with embodiments of the invention.

### DETAILED DESCRIPTION

The embodiments set forth below represent the necessary information to enable those skilled in the art to practice the invention and illustrate the best mode of practicing embodiments of the invention. Upon reading the following description in light of the accompanying figures, those skilled in the art will understand the concepts of the invention and recognize applications of these concepts not particularly addressed herein. It should be understood that these concepts and applications fall within the scope of the disclosure and the accompanying claims.

The preferred embodiment of the invention will now be described with reference to the accompanying drawings. The invention may, however, be embodied in many different forms and should not be construed as limited to the embodiment set forth herein; rather, this embodiment is provided so that this disclosure will be thorough and complete, and will fully convey the scope of the invention to those skilled in the art. The terminology used in the detailed description of the particular embodiment illustrated in the accompanying drawings is not intended to be limiting of the invention. In the drawings, like numbers refer to like elements.

The sender of link state information (the identified node) can tag information to be stored in a receiver node's database, but not used by the receiver node to compute routes transiting through the sender node. Other nodes can calculate routes to the identified node, but not routes that transit the identified node. This allows the identified node to control on a granular basis routes calculated through it by other nodes. The tag is implemented by way of a Type Length Value (TLV) included in Link State Packet (LSP) 0 that is flooded to all nodes in the network. The TLV contains sub-TLVs to provide control of route calculation by NLPID, address family or service type within an address family.

This TLV value indicates to other nodes to not calculate routes through the identified node. Computations of routes through the identified node are delayed as long as the TLV value indicates that routes should not be calculated through the identified node. Once the identified node is ready to have routes calculated that go through itself, it can withdraw the TLV to rescind the tag, and the identified node can now be used in route calculations. The other nodes see that the TLV has been withdrawn and can update their routing tables almost simultaneously regarding the availability of the identified node for route calculations. This provides, for example, the ability to synchronize L2 information while still providing L3 routing, or provide the ability to reduce the amount of calculations performed by a node for every piece of information the node receives. This can also be used to reduce churn and changes within routing tables. This method also provides the ability to converge with other protocols. For example, if you are bringing Border gateway Protocol (BGP) routes into ISIS, it may be desirable to wait for all the BGP information to be received instead of working with bits and pieces of the BGP information.

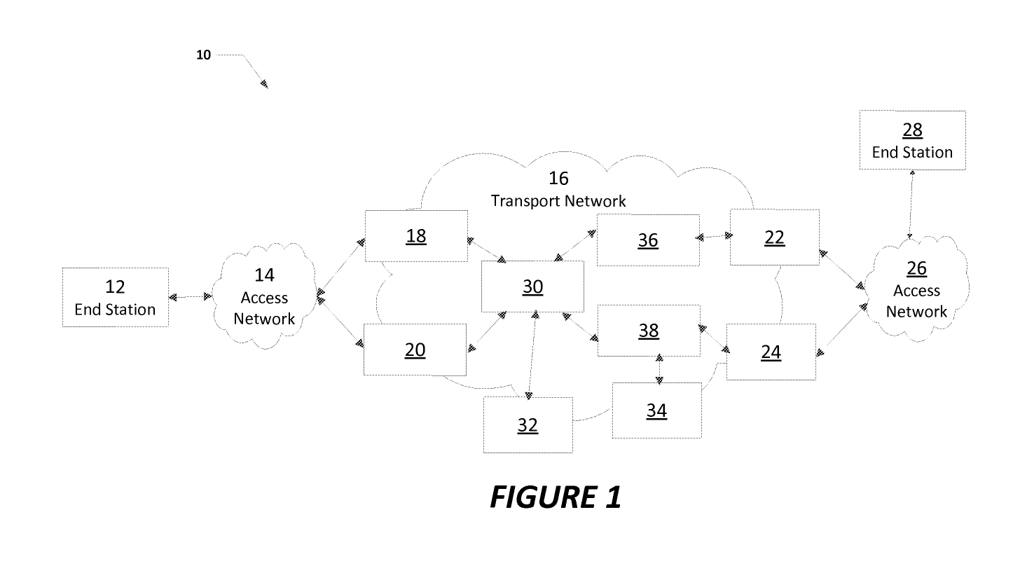

FIG. 1 illustrates an environment 10 wherein a first access network 14 and a second access network 28 are interconnected by way of a transport network 16. Transport network 16 in this example is a Shortest Path Bridging (SPB) network. The transport network 16 includes a group of network devices, 18, 20, 22, 24, 30, 32, 34, 36 and 38.

Network devices 18, 20, 22, 24, 32 and 34 are herein referred to as Backbone Edge Bridges (BEBs or edge devices) while network devices 30, 36 and 38 are herein referred to as Backbone Core Bridges (BCBs or core devices). A packet transmitted from an edge station 12 through access network 14 destined for edge station 28 through access network 26 would enter transport network 16 via BEB 20, be forwarded to BCB 30, be forwarded to BCB 38, forwarded to BEB24 then to access network 26.

SPB combines an Ethernet data path (either IEEE 802.1Q in the case of SPB, or Provider Backbone Bridges (PBBs) IEEE 802.1ah in the case of SPBM) with an IS-IS link state control protocol running between Shortest Path bridges (NNI links). The link state protocol is used to discover and advertise the network topology and compute shortest path trees from all bridges in the SPB Region. Topology data is the input to a calculation engine which computes symmetric shortest path trees based on minimum cost from each participating node to all other participating nodes. The shortest path trees are then used to populate forwarding tables for each participating node.

In SPB as with other link state based protocols, the computations are done in a distributed fashion. Each node computes the Ethernet compliant forwarding behavior independently based on a normally synchronized common view of the network (at scales of about 1000 nodes or less) and the service attachment points (UNI ports). Ethernet filtering Database (or forwarding) tables are populated locally to independently and deterministically implement its portion of the network forwarding behavior.

The Overload bit is special bit in the IS-IS LSP used to inform the network that the advertising router is not yet ready to forward transit traffic. The overload bit was first intended for signaling overload or resource shortage on specific router for the rest of the network. A command is used on a first network device to signal other network devices not to use the first network device as a transit hop in their SPF calculations. Typically this is done for a temporary situation like an overloaded router due to memory or processing shortage and released when the router recovers from the problematic situation. The Overload bit is a simple and handy technique that can be used whenever it is desirable to isolate a specific router in the network before a maintenance operation, attack or to avoid problematic path. The overload bit is typically used to verify operation of new installed routers before allowing them to forward transit traffic, to prevent control plane routers (e.g. Route Reflectors) from being used accidentally in the forwarding path, on routers' start-up to avoid traffic black-holes until routing protocols are fully converged, and to isolate a specific router before decommissioning or a maintenance operation.

Referring to FIG. 1, if router 18 were to have the overload bit, then router 18 would signal other devices in the transport network 16 not to use the router 18 as a transit hop in their route calculations. This overload bit signifies an all or nothing situation, wherein the network device 18 is not to be used for any route calculations that transit the network device on route calculations by the other network devices. Clearing the bit would result in network device 18 signaling other devices in the transport network 16 that they can now use the router 18 as a transit hop in their route calculations.

In accordance with the present invention, a degree of granularity is provided wherein route calculation for a network device is delayed on a per NPLID, per address family or per service within an address family. For example, network device 18 sets a value in LSP 0 that indicates to the other network devices in the network not to use network device 18 for Layer 2 (L2) routing but that network device 18 can be used for Layer 3 (L3) routing. Once all the L2 information is synchronized, network device 18 can rescind by withdrawing the TLV such that other nodes can now use network device 18 for L2 and L3 routing.

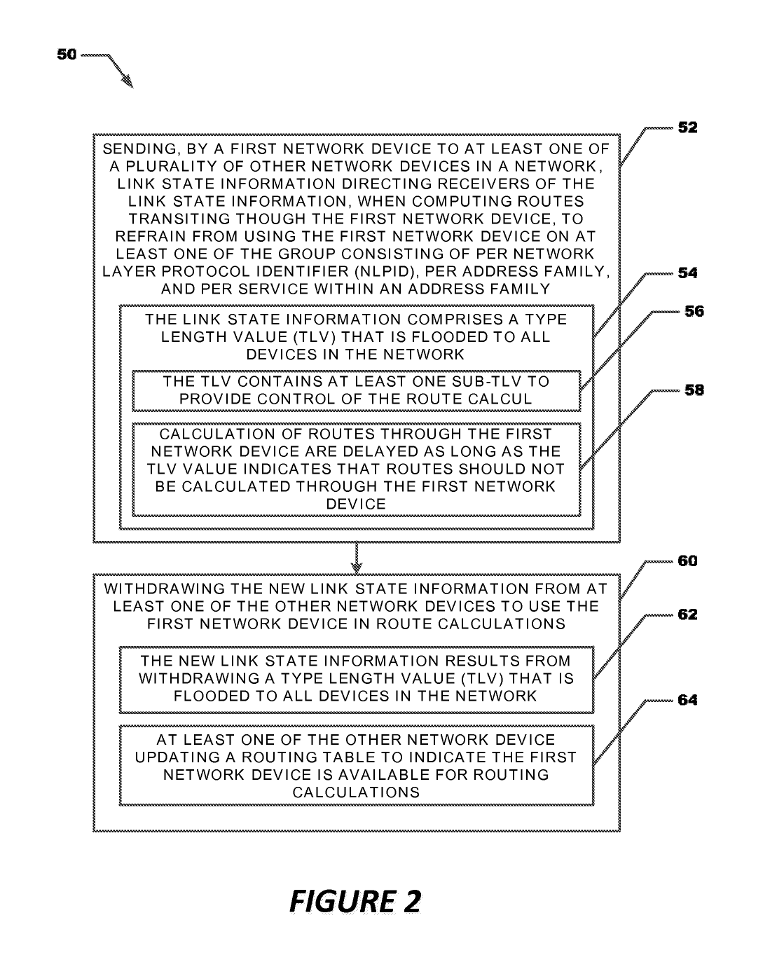

A flow chart of the presently disclosed method is depicted in FIG. 2. The rectangular elements are herein denoted “processing blocks” and represent computer software instructions or groups of instructions. Alternatively, the processing blocks represent steps performed by functionally equivalent circuits such as a digital signal processor circuit or an application specific integrated circuit (ASIC). The flow diagrams do not depict the syntax of any particular programming language. Rather, the flow diagrams illustrate the functional information one of ordinary skill in the art requires to fabricate circuits or to generate computer software to perform the processing required in accordance with the present invention. It should be noted that many routine program elements, such as initialization of loops and variables and the use of temporary variables are not shown. It will be appreciated by those of ordinary skill in the art that unless otherwise indicated herein, the particular sequence of steps described is illustrative only and can be varied without departing from the spirit of the invention. Thus, unless otherwise stated the steps described below are unordered meaning that, when possible, the steps can be performed in any convenient or desirable order.

Referring now to FIG. 2, a particular embodiment of a method 50 for providing delayed path calculation based on service type is shown. Method 50 begins with processing block 52 which discloses sending, by a first network device to at least one of a plurality of other network devices in a network, link state information directing receivers of the link state information, when computing routes transiting though the first network device, to refrain from using the first network device on at least one of the group consisting of per Network Layer Protocol Identifier (NLPID), per address family, and per service within an address family. As shown in processing block 52, the link state information comprises a Type Length Value (TLV) that is flooded to all devices in the network. As further shown in processing block 56 the TLV contains at least one sub-TLV to provide control of the route calculations. Processing block 58 states that the calculation of routes through the first network device are delayed as long as the TLV value indicates that routes should not be calculated through the first network device.

Processing continues with processing block 60 which recites withdrawing link state information to at least one of the other network devices to use the first network device in route calculations. As shown in processing block 62 the new link state information comprises withdrawing a Type Length Value (TLV) that is flooded to all devices in the network. Processing block 64 discloses the at least one of the other network device updating a routing table to indicate the first network device is available for routing calculations.

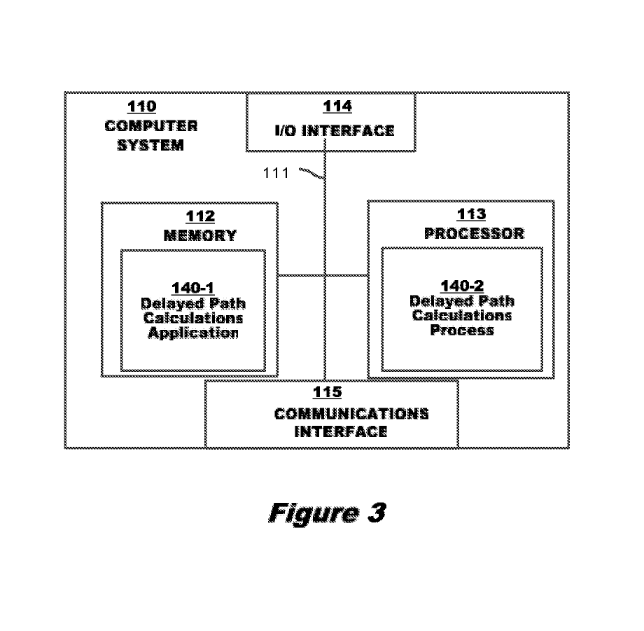

FIG. 3 is a block diagram illustrating example architecture of a computer system 110 that executes, runs, interprets, operates or otherwise performs a delayed path calculation application 140-1 and delayed path calculation process 140-2 suitable for use in explaining example configurations disclosed herein. The computer system 110 may be any type of computerized device such as a personal computer, workstation, portable computing device, console, laptop, network terminal or the like. An input device 116 (e.g., one or more customer/developer controlled devices such as a keyboard, mouse, etc.) couples to processor 113 through I/O interface 114, and enables a customer 108 to provide input commands, and generally control the graphical customer interface 160 that the delayed path calculation application 140-1 and process 140-2 provides on the display 130. Essentially, the graphical user interface 160 is where the customer 108-1 performs their ‘online banking’, specifying which bills are to be paid electronically, when those bills are to be paid, and the amount to be paid. As shown in this example, the computer system 110 includes an interconnection mechanism 111 such as a data bus or other circuitry that couples a memory system 112, a processor 113, an input/output interface 114, and a communications interface 115. The communications interface 115 enables the computer system 110 to communicate with other devices (i.e., other computers) on a network (not shown).

The memory system 112 is any type of computer readable medium, and in this example, is encoded with a delayed path calculation application 140-1 as explained herein. The delayed path calculation application 140-1 may be embodied as software code such as data and/or logic instructions (e.g., code stored in the memory or on another computer readable medium such as a removable disk) that supports processing functionality according to different embodiments described herein. During operation of the computer system 110, the processor 113 accesses the memory system 112 via the interconnect 111 in order to launch, run, execute, interpret or otherwise perform the logic instructions of a delayed path calculation application 140-1. Execution of a delayed path calculation application 140-1 in this manner produces processing functionality in the delayed path calculation process 140-2. In other words, the delayed path calculation process 140-2 represents one or more portions or runtime instances of a delayed path calculation application 140-1 (or the entire a delayed path calculation application 140-1) performing or executing within or upon the processor 113 in the computerized device 110 at runtime.

It is noted that example configurations disclosed herein include the delayed path calculation application 140-1 itself (i.e., in the form of un-executed or non-performing logic instructions and/or data). The delayed path calculation application 140-1 may be stored on a computer readable medium (such as a floppy disk), hard disk, electronic, magnetic, optical, or other computer readable medium. A delayed path calculation application 140-1 may also be stored in a memory system 112 such as in firmware, read only memory (ROM), or, as in this example, as executable code in, for example, Random Access Memory (RAM). In addition to these embodiments, it should also be noted that other embodiments herein include the execution of a delayed path calculation application 140-1 in the processor 113 as the delayed path calculation process 140-2. Those skilled in the art will understand that the computer system 110 may include other processes and/or software and hardware components, such as an operating system not shown in this example.

A display 130 need not be coupled directly to computer system 110. For example, the delayed path calculation application 140-1 can be executed on a remotely accessible computerized device via the network interface 115. In this instance, the graphical customer interface 160 may be displayed locally to a customer 108 of the remote computer, and execution of the processing herein may be client-server based.

During operation, processor 113 of computer system 100 accesses memory system 112 via the interconnect 111 in order to launch, run, execute, interpret or otherwise perform the logic instructions of the delayed path calculation application 140-1. Execution of delayed path calculation application 140-1 produces processing functionality in delayed path calculation process 140-2. In other words, the delayed path calculation process 140-2 represents one or more portions of the delayed path calculation application 140-1 (or the entire application) performing within or upon the processor 113 in the computer system 100.

It should be noted that, in addition to the delayed path calculation process 140-2, embodiments herein include the delayed path calculation application 140-1 itself (i.e., the un-executed or non-performing logic instructions and/or data). The delayed path calculation application 140-1 can be stored on a computer readable medium such as a floppy disk, hard disk, or optical medium. The delayed path calculation application 140-1 can also be stored in a memory type system such as in firmware, read only memory (ROM), or, as in this example, as executable code within the memory system 112 (e.g., within Random Access Memory or RAM).

In addition to these embodiments, it should also be noted that other embodiments herein include the execution of delayed path calculation application 140-1 in processor 113 as the delayed path calculation process 140-2. Those skilled in the art will understand that the computer system 100 can include other processes and/or software and hardware components, such as an operating system that controls allocation and use of hardware resources associated with the computer system 100.

The device(s) or computer systems that integrate with the processor(s) may include, for example, a personal computer(s), workstation(s) (e.g., Sun, HP), personal digital assistant(s) (PDA(s)), handheld device(s) such as cellular telephone(s), laptop(s), handheld computer(s), or another device(s) capable of being integrated with a processor(s) that may operate as provided herein. Accordingly, the devices provided herein are not exhaustive and are provided for illustration and not limitation.

References to “a microprocessor” and “a processor”, or “the microprocessor” and “the processor,” may be understood to include one or more microprocessors that may communicate in a stand-alone and/or a distributed environment(s), and may thus be configured to communicate via wired or wireless communications with other processors, where such one or more processor may be configured to operate on one or more processor-controlled devices that may be similar or different devices. Use of such “microprocessor” or “processor” terminology may thus also be understood to include a central processing unit, an arithmetic logic unit, an application-specific integrated circuit (IC), and/or a task engine, with such examples provided for illustration and not limitation.

Furthermore, references to memory, unless otherwise specified, may include one or more processor-readable and accessible memory elements and/or components that may be internal to the processor-controlled device, external to the processor-controlled device, and/or may be accessed via a wired or wireless network using a variety of communications protocols, and unless otherwise specified, may be arranged to include a combination of external and internal memory devices, where such memory may be contiguous and/or partitioned based on the application. Accordingly, references to a database may be understood to include one or more memory associations, where such references may include commercially available database products (e.g., SQL, Informix, Oracle) and also proprietary databases, and may also include other structures for associating memory such as links, queues, graphs, trees, with such structures provided for illustration and not limitation.

References to a network, unless provided otherwise, may include one or more intranets and/or the internet, as well as a virtual network. References herein to microprocessor instructions or microprocessor-executable instructions, in accordance with the above, may be understood to include programmable hardware.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems.

Throughout the entirety of the present disclosure, use of the articles “a” or “an” to modify a noun may be understood to be used for convenience and to include one, or more than one of the modified noun, unless otherwise specifically stated.

Elements, components, modules, and/or parts thereof that are described and/or otherwise portrayed through the figures to communicate with, be associated with, and/or be based on, something else, may be understood to so communicate, be associated with, and or be based on in a direct and/or indirect manner, unless otherwise stipulated herein.

Although the methods and systems have been described relative to a specific embodiment thereof, they are not so limited. Obviously many modifications and variations may become apparent in light of the above teachings. Many additional changes in the details, materials, and arrangement of parts, herein described and illustrated, may be made by those skilled in the art.

Having described preferred embodiments of the invention it will now become apparent to those of ordinary skill in the art that other embodiments incorporating these concepts may be used. Additionally, the software included as part of the invention may be embodied in a computer program product that includes a computer useable medium. For example, such a computer usable medium can include a readable memory device, such as a hard drive device, a CD-ROM, a DVD-ROM, or a computer diskette, having computer readable program code segments stored thereon. The computer readable medium can also include a communications link, either optical, wired, or wireless, having program code segments carried thereon as digital or analog signals. Accordingly, it is submitted that that the invention should not be limited to the described embodiments but rather should be limited only by the spirit and scope of the appended claims.

What is claimed is:

1. A computer-implemented method in which a computer system performs operations comprising:
sending, by a first network device to at least one of a plurality of other network devices in a network, link state information directing receivers of said link state information, when computing routes transiting though said first network device,
to refrain from using said first network device on at least one of the group consisting of per Network Layer Protocol Identifier (NLPID), per address family, and per service within an address family.

2. The method of claim 1 wherein said link state information comprises a Type Length Value (TLV) that is flooded to all devices in said network.

3. The method of claim 2 wherein said TLV contains at least one sub-TLV to provide control of said route calculations.

4. The method of claim 2 wherein calculation of routes through said first network device are delayed as long as said TLV value indicates that routes should not be calculated through said first network device.

5. The method of claim 1 further comprising withdrawing link state information to at least one of said other network devices to use said first network device in route calculations.

6. The method of claim 5 wherein said link state information comprises a Type Length Value (TLV) that is withdrawn and flooded to all devices in said network.

7. The method of claim 6 further comprising said at least one of said other network device updating a routing table to indicate said first network device is available for routing calculations.

8. A non-transitory computer readable storage medium having computer readable code thereon for providing delayed path calculations based on service type, the medium including instructions in which a computer system performs operations comprising:
sending, by a first network device to at least one of a plurality of other network devices in a network, link state information directing receivers of said link state information, when computing routes transiting though said first network device,
to refrain from using said first network device on at least one of the group consisting of per Network Layer Protocol Identifier (NLPID), per address family, and per service within an address family.

9. The non-transitory computer readable storage medium of claim 8 further comprising instructions wherein said link state information comprises a Type Length Value (TLV) that is flooded to all devices in said network.

10. The non-transitory computer readable storage medium of claim 9 further comprising instructions wherein said TLV contains at least one sub-TLV to provide control of said route calculations.

11. The non-transitory computer readable storage medium of claim 9 further comprising instructions wherein calculation of routes through said first network device are delayed as long as said TLV value indicates that routes should not be calculated through said first network device.

12. The non-transitory computer readable storage medium of claim 8 further comprising instructions for withdrawing link state information to at least one of said other network devices to use said first network device in route calculations.

13. The non-transitory computer readable storage medium of claim 12 further comprising instructions wherein said link state information comprises a Type Length Value (TLV) that is withdrawn and flooded to all devices in said network.

14. The non-transitory computer readable storage medium of claim 13 further comprising instructions wherein said at least one of said other network device updating a routing table to indicate said first network device is available for routing calculations.

15. A network device comprising:
a memory;
a processor;
a communications interface;
an interconnection mechanism coupling the memory, the processor and the communications interface; and
wherein the memory is encoded with an application providing delayed path calculations based on service type, that when performed on the processor, provides a process for processing information, the process causing the network device to perform the operations of:
sending, by said network device to at least one of a plurality of other network devices in a network, link state information directing receivers of said link state information, when computing routes transiting though said first network device,
to refrain from using said first network device on at least one of the group consisting of per Network Layer Protocol Identifier (NLPID), per address family, and per service within an address family.

16. The network device of claim 15 wherein said link state information comprises a Type Length Value (TLV) that is flooded to all devices in said network.

17. The network device of claim 16 wherein said TLV contains at least one sub-TLV to provide control of said route calculations.

18. The network device of claim 16 wherein calculation of routes through said network device are delayed as long as said TLV value indicates that routes should not be calculated through said network device.

19. The network device of claim 15 further comprising withdrawing link state information to at least one of said other network devices to use said first network device in route calculations.

20. The network device of claim 19 wherein said link state information comprises a Type Length Value (TLV) that is withdrawn and flooded to all devices in said network.
